(19) United States
(12) Patent Application Publication
(10) Pub. No.: US 2026/0029607 A1
(43) Pub. Date: Jan. 29, 2026

(54) LENS ASSEMBLY

(71) Applicant: Samsung Electro-Mechanics Co., Ltd., Suwon-si (KR)

(72) Inventors: Soo Hyun CHO, Suwon-si (KR); Young Su JIN, Suwon-si (KR)

(73) Assignee: Samsung Electro-Mechanics Co., Ltd., Suwon-si (KR)

(21) Appl. No.: 19/058,328

(22) Filed: Feb. 20, 2025

(30) Foreign Application Priority Data
Jul. 23, 2024 (KR) 10-2024-0097279

(51) Int. Cl. G02B 7/02

(52) U.S. Cl. CPC G02B 7/021

(57) ABSTRACT

A lens assembly is provided. The lens assembly includes a lens barrel; a plurality of lenses arranged in an optical axis direction and disposed in the lens barrel; and a first spacer disposed between a (N)th lens and a (N+1)th lens, which are adjacent among the plurality of lenses, wherein the (N)th lens may be formed of a first plastic material, and the first spacer may be formed of a same material as the first plastic material, or may be formed of a second plastic material which has a higher coefficient of hygroscopic expansion than a coefficient of hygroscopic expansion of the first plastic, and wherein N is a natural number of two or more.

### CROSS-REFERENCE TO RELATED APPLICATIONS

This application claims benefit under 35 USC § 119(a) of Korean Patent Application No. 10-2024-0097279 filed on Jul. 23, 2024, in the Korean Intellectual Property Office, the entire disclosure of which is incorporated herein by reference for all purposes.

### BACKGROUND

### 1. Field

The following description relates to a technology related to a lens assembly.

### 2. Description of Related Art

Camera modules have been implemented in portable electronic devices, such as, but not limited to, smartphones, and such camera modules are typically provided with a lens assembly including a plurality of lenses.

Typically, at least one of the plurality of lenses may be formed of a plastic material, and the plurality of lenses may be comprised of a combination of lenses having different refractive index.

In the example of lenses that are formed of a plastic material with a high refractive index, the characteristic of the material may make them vulnerable to the effects of temperature and humidity, and interference may occur with surrounding structures due to differences in expansion rates of the material, which may cause a problem in which optical performance deteriorates when the environment changes rapidly.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a lens assembly includes a lens barrel; a plurality of lenses arranged in a direction of an optical axis, and disposed in the lens barrel; and a first spacer disposed between a (N)th lens and a (N+1)th lens, which are adjacent among the plurality of lenses, wherein the (N)th lens is formed of a first plastic material, wherein the first spacer is formed of a same material as the first plastic material, or is formed of a second plastic material which has a higher coefficient of hygroscopic expansion (CHE) than a coefficient of hygroscopic expansion of the first plastic material, and wherein N is a natural number of two or more.

The first spacer may include a first coupling protrusion that protrudes toward the (N)th lens, and wherein the (N)th lens may include a second coupling protrusion that protrudes toward the first spacer, and the second coupling protrusion is coupled with the first coupling protrusion.

The first coupling protrusion may contact the (N)th lens in the direction of the optical axis and in a direction intersecting the optical axis, and the second coupling protrusion may contact the first spacer in the direction of the optical axis and in the direction intersecting the optical axis.

An outer surface of the (N)th lens may be in contact with the lens barrel.

The first coupling protrusion and the second coupling protrusion may be disposed parallel to each other in a direction perpendicular to the optical axis, and the first coupling protrusion may be disposed closer to the optical axis in the direction perpendicular to the optical axis than the second coupling protrusion.

An inner surface of the second coupling protrusion may be disposed to contact an outer surface of the first coupling protrusion.

The outer surface of the first coupling protrusion may be inclined with respect to the optical axis, and the inner surface of the second coupling protrusion may be formed parallel to the outer surface of the first coupling protrusion.

The outer surface of the first coupling protrusion may be formed to have an angle (θ) of 90° to 135° with an upper surface of the first spacer.

A first number of lenses of the plurality of lenses including the (N)th lens may be formed of a polycarbonate series plastic material.

The first spacer may be formed of a plastic material of a polycarbonate series, a nylon series, or a styrene series.

The (N)th lens and the (N+1)th lens may be disposed at a wider interval than lenses disposed on an object side of the (N)th lens.

Other features and aspects will be apparent from the following detailed description, the drawings, and the claims.

### BRIEF DESCRIPTION OF DRAWINGS

FIG. 1 illustrates a schematic cross-sectional view of an example general lens assembly, in accordance with one or more embodiments.

FIG. 2 illustrates a cross-sectional view of an example lens assembly, in accordance with one or more embodiments.

FIG. 3 illustrates a perspective view of an example first spacer, in accordance with one or more embodiments.

FIG. 4 illustrates an enlarged view of part A of FIG. 2.

FIG. 5 illustrates the principle of suppressing lens deformation in a structure of FIG. 4.

FIG. 6 illustrates an enlarged view of part B of FIG. 2.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

The one or more examples relate to a lens assembly, and more specifically, to a lens assembly that responds to deformation of a lens.

One or more examples may provide a lens assembly that prevents performance degradation due to external factors.

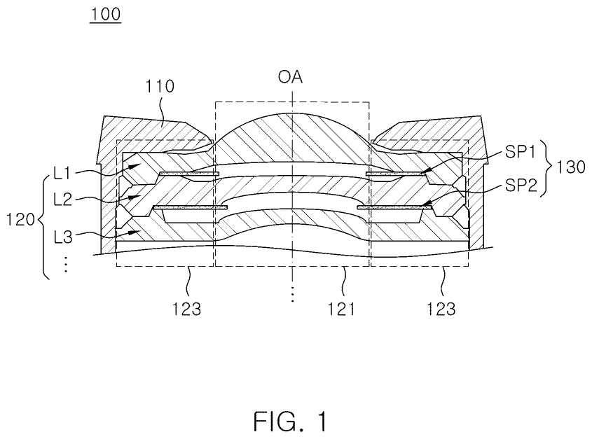

FIG. 1 illustrates a schematic cross-sectional view of a typical lens assembly 100. The lens assembly 100 may comprise a lens barrel 110, a plurality of lenses 120 and at least one spacer 130. The plurality of lenses 120 and the spacer 130 may all be disposed inside the lens barrel 110.

The plurality of lenses 120 may include a first lens L1, a second lens L2, a third lens L3, etc., disposed along the optical axis (OA). The plurality of lenses 120 may be disposed spaced apart from each other by a preset distance along the optical axis (OA). Additionally, the plurality of lenses 120 may be circular lenses or D-cut lenses with a portion of an outline cut off.

The plurality of lenses 120 may include an optical portion 121 and a rib 123 (or flange) that extends in a direction perpendicular to the optical axis direction from the optical portion 121.

The optical portion 121 is a portion where the optical performance of the lens is demonstrated, and a diameter of an edge of the optical portion 121 may correspond to an effective diameter of the lens. Light reflected from an external subject may be incident on the optical portion 121 of the lens, and may be refracted while passing through the optical portion 121. The optical portion 121 of adjacent lenses may be spaced apart from each other by a preset distance in a direction parallel to the optical axis (OA).

The rib 123 may be a portion that fastens the lens to another configuration, for example, a lens barrel 110 or another adjacent lens. The rib 123 is a portion that extends radially around the periphery of the optical portion 121 and may be formed integrally with the optical portion 121. In an example, the rib 123 of a specific lens may contact to the lens barrel 110, and may also contact to the rib 123 of the adjacent lens.

In an example, although not illustrated in the attached drawings, an image sensor may be disposed at a bottom portion of the lens barrel 110. Light reflected from an external subject may reach the image sensor through the plurality of lenses 120.

At least one spacer 130 may be disposed between adjacent lenses in the lens assembly 100. In an example, the spacer 130 may include a first spacer SP1 disposed between a first lens L1 and a second lens L2, a second spacer SP2 disposed between the second lens L2 and a third lens, etc. The spacer 130 may adjust a gap between adjacent lenses, or may block unnecessary light.

The spacer 130 may be disposed between adjacent lenses so as to contact the ribs 123 of the lenses. The spacer 130 may be manufactured with different thicknesses depending on a preset distance between the adjacent lenses.

The spacer 130 may include a through-hole which allows light to pass through. In an example, light passing through the optical portion 121 of the lens disposed on the object side of the spacer 130 may pass through the through-hole of the spacer 130 and enter the optical portion 121 of the lens disposed on a sensor side of the spacer 130.

The spacer 130 may be provided with a light absorbing layer to block unnecessary light. In a non-limited example, the light absorbing layer may be a black film or black iron oxide.

The spacer 130 may include a spacer that is formed of a metal material. In a non-limited example, the spacer that is formed of a metal material may be formed of a non-ferrous metal (e.g., phosphor bronze).

Additionally, in accordance with one or more embodiments, the spacer 130 may include a spacer that is formed of a plastic material. A detailed description thereof will be given below.

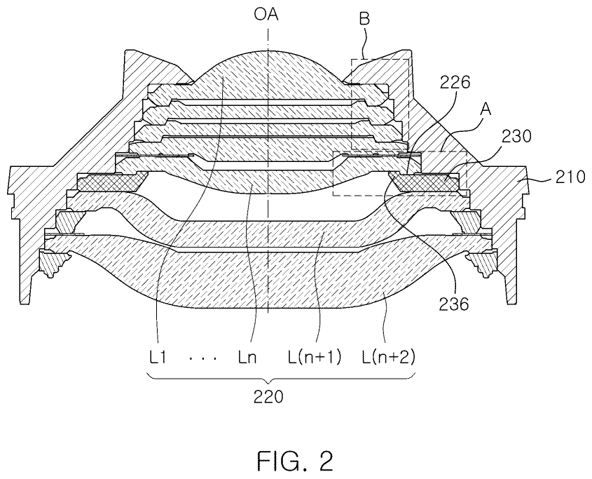

The contents of the lens assembly 100 described above may be mostly applied to a lens assembly 200 described below. Hereinafter, the lens assembly 200, in accordance with one or more embodiments, will be described with reference to FIGS. 2 to 6.

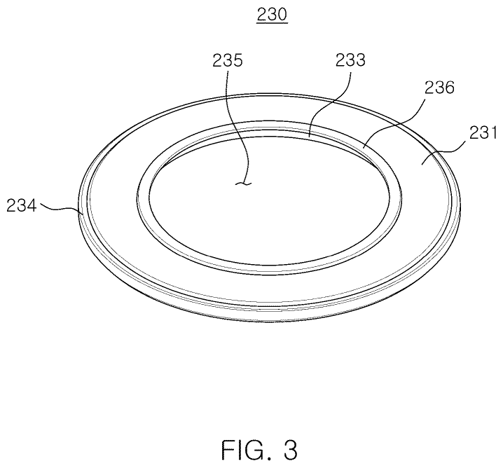

FIG. 2 is a cross-sectional view of the lens assembly 200, in accordance with one or more embodiments, and FIG. 3 is a perspective view of a first spacer 230, in accordance with one or more embodiments.

Referring to FIG. 2, a lens assembly 200, in accordance with one or more embodiments, may include a lens barrel 210, a plurality of lenses 220 disposed in the direction of the optical axis (OA) inside the lens barrel 210, and a first spacer 230 that may be formed of a plastic material disposed between adjacent lenses among the plurality of lenses 220.

The plurality of lenses 220 may be configured to include n+2 lenses (where n is a natural number of two or more). The lens assembly 200 may include four or more lenses, and preferably, six or more lenses.

The plurality of lenses 220 may have an object-side surface and an image-side surface, and they may be formed in a concave or convex shape toward an object side or an image side depending on a desired optical performance. Alternatively, the plurality of lenses 220 may be provided in a flat surface (the shape of the plurality of lenses 220 illustrated in FIG. 2 is only an example).

The plurality of lenses 220 may be disposed within the lens barrel 210 so as to be in contact with the lens barrel 210. In an example, the plurality of lenses 220 may be in contact with the lens barrel 210 at least in a direction intersecting the optical axis.

The plurality of lenses 220 may be partially or entirely formed of a plastic material. Additionally, a portion of the plurality of lenses 220 may be provided with a hydrophilic plastic material which has high refractive index characteristics and high hygroscopic expansion coefficient. For example, partial of the plurality of lenses 220 may be provided with a polycarbonate series plastic material. However, the material of the partial of the lenses may not be limited to the materials mentioned above, and may be replaced with other materials having similar characteristics.

In an embodiment, the plurality of lenses 220 may include one or more polycarbonate series plastic material lenses. In case they include a plurality of lenses, they may be disposed continuously or discontinuously along the optical axis (OA). For example, in the lens assembly 200 illustrated in FIG. 2, at least an (N)th lens Ln may be a polycarbonate series plastic material lens.

The first spacer 230 illustrated in FIG. 3 may be disposed between the (N)th lens Ln and the (N+1)th lens L(n+1). In other words, in an example, the first spacer 230 may be disposed between a polycarbonate series plastic material lens and an adjacent lens.

The first spacer 230 may be provided with a plastic material having similar properties to the (N)th lens Ln, for example, a high hygroscopic expansion coefficient. Specifically, the first spacer 230 may be provided with a material having a coefficient of hygroscopic expansion (CHE) similar to, or greater than, a coefficient of hygroscopic expansion of the (N)th lens Ln. For example, the first spacer 230 may be a plastic material such as a polycarbonate series, a nylon series, or a styrene (ABS) series. However, the material of the first spacer 230 may not be limited to the materials mentioned above, and may be replaced with another material having similar properties.

In the one or more examples, the (N)th lens Ln and the first spacer 230 may be provided with a plastic material having a coefficient of hygroscopic expansion (CHE) of 0.05 to 0.6. In the one or more examples, the coefficient of hygroscopic expansion (CHE) may be defined as a deformation amount (Strain %/Weight Gain %) of the specimen for the amount of moisture absorbed under temperature and humidity conditions (in an environment where a measurement is performed).

TABLE 1

| Division | 1 | 2 | 3 |
|---|---|---|---|
| Temperature | 85° C. | 60° C. | 25° C. |
| Relative humidity | 85% | 90% | 50% |

In an example, the coefficient of hygroscopic expansion (CHE) of the polycarbonate series plastic material may be from 0.1 to 0.3, and preferably from 0.16 to 0.27. In an example, when the first spacer 230 is provided with a material different from a material of the (N)th lens Ln, the first spacer 230 may be provided with a plastic material having a coefficient of hygroscopic expansion (CHE) greater than a coefficient of hygroscopic expansion of a polycarbonate-based plastic material.

Additionally, in the example, the (N)th lens Ln and the (N+1)th lens L(n+1) may be disposed with a relatively wider gap than other neighboring lenses. For example, the (N)th lens Ln and the (N+1)th lens L(n+1) may be disposed with a wider gap than at least the lenses disposed on an object side of the (N)th lens Ln. The first spacer 230 may be formed to have a thickness corresponding to a preset distance between the (N)th lens Ln and the (N+1)th lens L(n+1) so as to maintain the gap between them.

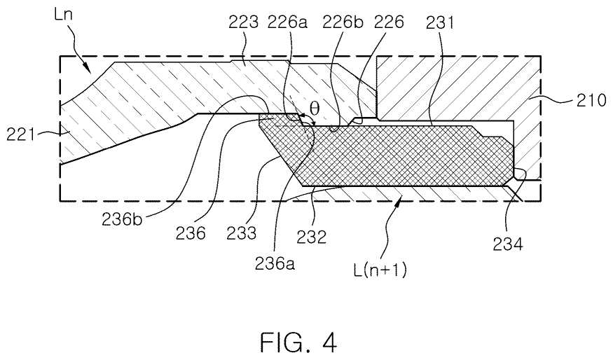

Referring to FIG. 3 and FIG. 4, in an example, the first spacer 230 may be formed in a circular shape and may be inserted and disposed inside the lens barrel 210.

The first spacer 230 may include an upper surface 231 and a lower surface 232 (FIG. 4) which face each other in a direction of the optical axis (OA), and side surfaces 233, 234 which connect the upper surface 231 and the lower surface 232. The side surfaces 233, 234 of the first spacer 230 may include an inner surface 233 which faces the optical axis (OA), and an outer surface 234 which faces in a radial direction.

The upper surface 231 and the lower surface 232 of the first spacer 230 may each have an annular shape, and a surface extending from an inner edge of the upper surface 231 to an inner edge of the lower surface 232 may constitute the inner surface 233. Additionally, a surface extending from an outer edge of the upper surface 231 to an outer edge of the lower surface 232 may constitute the outer surface 234. For example, the inner surface 233 of the first spacer 230 may be a surface that is formed obliquely with respect to the optical axis (OA), and the outer surface 234 may be a surface that is formed approximately parallel to the optical axis (OA). However, this is only an example, and in an example, the outer surface 234 may be changed to suit a shape of the lens barrel 210.

The upper surface 231 of the first spacer 230 may be in contact with an image-side rib 223 of the (N)th lens Ln, and the lower surface 232 may be in contact with an object-side rib 223 of the (N+1)th lens L(n+1). Additionally, the outer surface 234 of the first spacer 230 may be in contact with the lens barrel 210.

The first spacer 230 may include a through-hole 235. The inner surface 233 of the first spacer 230 may define the through-hole 235. Depending on a shape of the inner surface 233 of the first spacer 230, the through-hole 235 may have a shape in which a diameter expands from the upper surface 231 of the first spacer 230 to the lower surface 232 of the first spacer 230.

The through-hole 235 may overlap with an optical portion 221 of the (N)th lens Ln and the (N+1)th lens L(n+1) in the direction of the optical axis (OA).

In an example, the first spacer 230 may form a specific coupling protrusion by coming into contact with the rib 223 of the (N)th lens Ln. In FIG. 3, the upper surface 231 of the first spacer 230 may be provided with a first coupling protrusion 236 that protrudes from the upper surface 231 of the first spacer 230 along an inner edge. The first coupling protrusion 236 may form a coupling with a second coupling protrusion 226 that protrudes from the rib 223 of the (N)th lens Ln toward the first spacer 230.

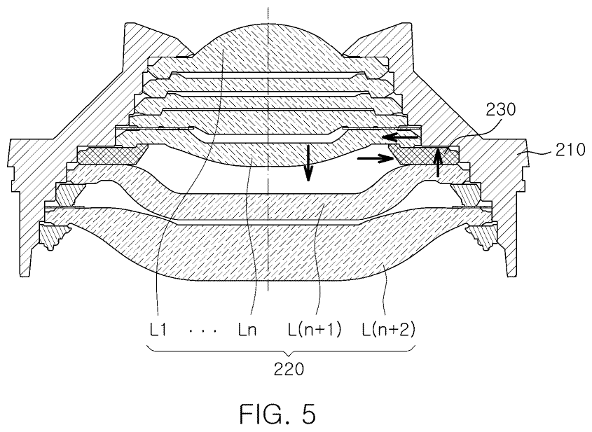

FIG. 4 illustrates an enlarged view of part A of FIG. 2, and FIG. 5 illustrates a principle of suppressing lens deformation in the structure of FIG. 4.

Referring to FIG. 4, the first coupling protrusion 236 of the first spacer 230 may be disposed inwardly, that is, closer to the optical axis (OA), than the second coupling protrusion 226 of the rib 223. For example, an outer radius of the first coupling protrusion 236 may be less than an inner radius of the second coupling protrusion 226, and the first coupling protrusion 236 and the second coupling protrusion 226 may be disposed parallel in a radial direction of a circle centered on the optical axis (OA).

The first coupling protrusion 236 and the second coupling protrusion 226 may be disposed so that they partially facing each other in a direction intersecting the optical axis (OA), and come into contact with each other. For example, an outer surface 236a of the first coupling protrusion 236 and an inner surface 226a of the second coupling protrusion 226 may come into contact with each other. That is, the first coupling protrusion 236 and the second coupling protrusion 226 may be disposed in surface contact.

Additionally, the first coupling protrusion 236 may contact a portion of the (N)th lens Ln, facing the (N)th lens in a direction of the optical axis (OA). Similarly, the second coupling protrusion 226 may contact a portion of the first spacer 230, facing the first spacer 230 in the direction of the optical axis (OA). For example, a protruding surface 236b of the first coupling protrusion 236 and the rib 223 of the (N)th lens Ln may contact each other. Additionally, a protruding surface 226b of the second coupling protrusion 226 and the upper surface 231 of the first spacer 230 may also contact each other.

As described above, when the lens assembly 200 is exposed to a high temperature and high humidity environment while the first spacer 230 that is formed of a material having a high hygroscopic expansion rate and the (N)th lens Ln are combined as described above, the deformation of the (N)th lens Ln may be offset by the deformation of the first spacer 230.

In a high temperature and high humidity environment, an external force due to deformation of the lens barrel 210 may be transmitted to multiple lenses 220. Specifically, in the example of the (N)th lens Ln, a shape of the lens (e.g., curvature) and a gap between the lenses may change due to an influence of an external force transmitted from the lens barrel 210 due to the characteristics of the material.

In an example, the (N)th lens Ln may have a meniscus shape that is a convex image side, and based on a force applied from an outer diameter to an inner diameter, it may change a gap between the adjacent lenses by bending from a concave object side to a convex image side. For example, with the above deformation, the gap between the (N)th lens Ln and the (N+1)th lens L(n+1) may be narrowed.

In accordance with one or more embodiments, an external force may be applied to the (N)th lens Ln from the first spacer 230 coupled with the (N)th lens Ln to offset the force deforming the (N)th lens Ln.

In the embodiment, the first spacer 230 may be deformed to expand in a longitudinal direction under high temperature and high humidity conditions. The first coupling protrusion 236 of the first spacer 230 may be disposed on the inner side of the second coupling protrusion 226 of the (N)th lens Ln, and comes into contact with a surface that faces in a direction intersecting the optical axis (OA) of the second coupling protrusion 226, so that the external force by the first spacer 230 may be transmitted from the inner diameter to the outer diameter, that is, in an opposite direction to the external force by the lens barrel 210.

The surfaces facing each other in a direction perpendicular to the optical axis (OA) of the first coupling protrusion 236 and the second coupling protrusion 226 may be inclined surfaces with respect to the optical axis (OA). In an example, the upper surface 231 of the first spacer 230 and the outer surface 236a of the first coupling protrusion 236 may have an angle (θ) between 90° and 135°. In this example, as the first spacer 230 expands, a force corresponding to the external force transmitted from the lens barrel 210 to the (N)th lens Ln may be applied to the (N)th lens Ln. The inner surface 226a of the second coupling protrusion 226 may be parallel to the outer surface 236a of the first coupling protrusion 236.

Referring to FIG. 5, in an example, the first spacer 230 may be expanded and deformed in a thickness direction as well as a length direction. The thickness direction may be a direction parallel to the optical axis (OA). In the example, the first spacer 230 and the (N)th lens Ln may be in contact in the direction of the optical axis (OA), so that the first spacer 230 may compensate for the change in the gap between the (N)th lens Ln and the n+1 lens L(n+1) due to a sagging of the (N)th lens Ln as it expands in the thickness direction.

In the above, the description may be mainly with regard to the example in which the lens assembly 200 may be exposed to a high temperature and high humidity environment, but conversely, the same principle may be applied even when a surrounding environment changes back to a room temperature and low humidity environment.

That is, the lens assembly 200, in accordance with one or more embodiments, may exhibit similar performance under all conditions because factors that may affect optical performance, such as a lens gap, remain almost constant even when the surrounding environment (temperature and humidity) changes, and thus performance stability may be improved.

Additionally, in a coupling structure, in accordance with the one or more embodiments, the first coupling protrusion 236 and the second coupling protrusion 226 may guide an assembly position of the (N)th lens Ln, thereby helping to align the optical axis (OA) of the (N)th lens Ln.

Similarly, the ribs 223 of other lenses may also be provided with a configuration that guides the assembly position.

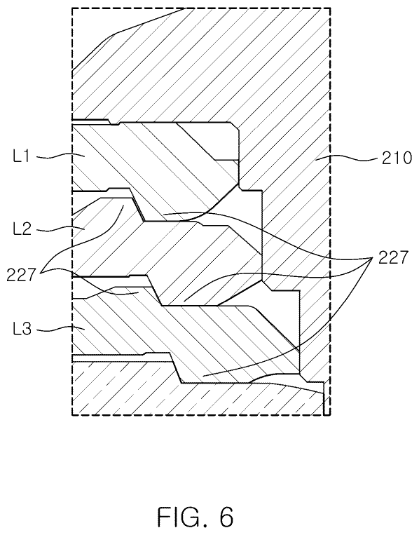

FIG. 6 is an enlarged view of part B of FIG. 2.

Referring to FIG. 6, the plurality of lenses 220 may include a protrusion 227 that protrudes toward the rib 223 of the lens disposed adjacent to the rib 223.

In an example, the first lens L1 may include the protrusion 227 that protrudes toward the second lens L2 that is disposed adjacently. In the example of the second lens L2, since the second lens L2 is adjacent to the first lens L1 on an object side and adjacent to the third lens L3 on an image side, the second lens L2 may include protrusions 227 that protrude toward the first lens L1 and the third lens L3, respectively.

The assembly position of the plurality of lenses 220 may be guided so that the optical axes (OA) may be aligned by the protrusions 227 provided on the surfaces facing each other. Accordingly, decentering may be prevented without applying a separate structure to align the optical axes (OA) of the plurality of lenses 220 to the lens barrel 210.

In accordance with the one or more embodiments, since lens performance may be maintained even in various usage environments, product reliability may be improved.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A lens assembly, comprising:
a lens barrel;
a plurality of lenses arranged in a direction of an optical axis, and disposed in the lens barrel; and
a first spacer disposed between a (N)th lens and a (N+1)th lens, which are adjacent among the plurality of lenses,
wherein the (N)th lens is formed of a first plastic material,
wherein the first spacer is formed of a same material as the first plastic material, or is formed of a second plastic material which has a higher coefficient of hygroscopic expansion (CHE) than a coefficient of hygroscopic expansion of the first plastic material, and
wherein N is a natural number of two or more.

2. The lens assembly of claim 1, wherein the first spacer comprises a first coupling protrusion that protrudes toward the (N)th lens, and
wherein the (N)th lens comprises a second coupling protrusion that protrudes toward the first spacer, and the second coupling protrusion is coupled with the first coupling protrusion.

3. The lens assembly of claim 2, wherein:
the first coupling protrusion contacts the (N)th lens in the direction of the optical axis and in a direction intersecting the optical axis, and
the second coupling protrusion contacts the first spacer in the direction of the optical axis and in the direction intersecting the optical axis.

4. The lens assembly of claim 3, wherein an outer surface of the (N)th lens is in contact with the lens barrel.

5. The lens assembly of claim 3, wherein:
the first coupling protrusion and the second coupling protrusion are disposed parallel to each other in a direction perpendicular to the optical axis, and
the first coupling protrusion is disposed closer to the optical axis in the direction perpendicular to the optical axis than the second coupling protrusion.

6. The lens assembly of claim 5, wherein:
an inner surface of the second coupling protrusion is disposed to contact an outer surface of the first coupling protrusion.

7. The lens assembly of claim 6, wherein:
the outer surface of the first coupling protrusion is inclined with respect to the optical axis, and
the inner surface of the second coupling protrusion is formed parallel to the outer surface of the first coupling protrusion.

8. The lens assembly of claim 7, wherein:
the outer surface of the first coupling protrusion is formed to have an angle (θ) of 90° to 135° with an upper surface of the first spacer.

9. The lens assembly of claim 1, wherein:
a first number of lenses of the plurality of lenses including the (N)th lens are formed of a polycarbonate series plastic material.

10. The lens assembly of claim 1, wherein the first spacer is formed of a plastic material of a polycarbonate series, a nylon series, or a styrene series.

11. The lens assembly of claim 1, wherein the (N)th lens and the (N+1)th lens are disposed at a wider interval than lenses disposed on an object side of the (N)th lens.
